(19) United States
(12) Patent Application Publication
(10) Pub. No.: US 2005/0160160 A1
(43) Pub. Date: Jul. 21, 2005

(54) Method and system for unified session control of multiple management servers on network appliances

(75) Inventor: Bing Wang, San Jose, CA (US)

Correspondence Address: DARBY & DARBY P.C., P.O. BOX 5257, NEW YORK, NY, 10150-6257, US

(73) Assignee: Nokia, Inc., Irving, TX (US)

(21) Appl. No.: 10/748,459

(22) Filed: Dec. 29, 2003

(51) Int. Cl. G06F 15/173

(52) U.S. Cl. 709/223

(57) ABSTRACT

Methods and systems are directed to managing sessions between users and a plurality of management servers on a network appliance. A unified session manager authenticates a user requesting access to a network appliance. The unified session manager then establishes a brokering session with a management server associated with a component application. The unified session manager may translate graphical user interface (GUI) messages between the user and the management server, while the user is in session with the network appliance. This provides the user with a uniform interface for the plurality of management servers. In another embodiment, the unified session manager may modify network addresses between the user and the management server. In yet another embodiment, the unified session manager may make a program from the network appliance available to the user to download directly from the unified session manager.

### FIELD OF THE INVENTION

The present invention relates to software integration, and in particular, to a method and system for managing multiple management servers by a single unified session manager to provide a unified session control.

### BACKGROUND

In today's network environment a variety of applications may be combined in a network device, such as a network appliance, and the like. Types, tasks and origins of the applications vary, as well as the types and numbers of management servers controlling them. For example, a network appliance may include virus scanning software, content filtering software, system management software, and the like. Each of the applications may come from a different manufacturer and each may have its own management server. Such a diverse array of applications may result in numerous problems, including the overall management of them remotely. Available integration solutions address some of the problems created by this variety, but fail to solve others.

One possible solution to the difficulty of managing multiple servers is to allow some management servers to work independently. This may require a user to access each management server separately for tasks related to an application associated with the management server. Further implications of this method involve the user having to deal with separate login procedures for each management server, encountering potentially, very different graphic user interfaces (GUIs), having to open multiple ports through a main firewall system, and the like.

Another commonly used method is to modify management servers in the network appliance to share login procedures, simplify access protocols, unify GUI's, and the like. This often may mean rewriting code for some of the management servers, requiring not only authorization and support from the manufacturers of individual applications, but also having to acquire the necessary knowledge and skill to rewrite the application.

A further method is to create a common interface and require all application manufacturers to be compatible with the common interface. This method may not be feasible in an open infrastructure system. Even in a closed system, it is likely to lead to increased cost and delay in a product introduction, as a complicated cooperation between multiple manufacturers may be needed.

Thus, it is with respect to these considerations and others that the present invention has been made.

### SUMMARY OF THE INVENTION

According to one aspect of the present invention, a method is directed to managing a network device. The method comprises receiving a request for access over a network to an application, establishing a session with a management server associated with the application, modifying and forwarding the request to the management server, receiving a response from the management server associated with the application, and modifying and forwarding the response from the management server.

According to another aspect of the present invention, a unified session manager is directed to managing a network device. The unified session manager comprises a first component configured to receive a request for access to an application on the network device and forward a response in return, and a second component, coupled to the first component, configured to establish a session with a management server associated with the application, to modify and forward the request to the management server, to receive the response from the management server associated with the application, and to modify and forward the response from the management server to the first component to be forwarded.

According to a further aspect of the present invention, a method is directed to managing a plurality of management servers. The method comprises establishing a session between a unified session manager and at least one of the plurality of the management servers, wherein the unified session manager is enabled to operate on behalf of a client requesting access to an application associated with the management server, and modifying a message between the client and at least one of the plurality of the management servers, wherein the modification is transparent to the client and the management server.

According to yet another aspect of the present invention, in a computer system having a graphical user interface including a display and a user interface selection device, a method is directed to providing a selecting menu on the display to access an application over a network. The method comprises retrieving a set of menu entries for the menu including at least access to an application access, and the like, displaying the menu on the display comprising the set of menu entries, retrieving a menu entry selection signal indicative of the user interface selection, wherein the menu entry selection signal is modified and forwarded to a management server associated with the application, and receiving another signal indicative of a response by the management server, wherein the signal is modified and forwarded to the user.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 illustrates one embodiment of an environment in which the invention may operate;

FIG. 2 illustrates a functional block diagram of a system in accordance with one embodiment of the present invention;

FIG. 3 illustrates a functional block diagram of a system in accordance with another embodiment of the present invention; and

FIG. 4 illustrates a flow diagram generally showing one embodiment of a process for using a unified session manager of multiple management servers.

### DETAILED DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

The terms “comprising,” “including,” “containing,” “having,” and “characterized by,” refers to an open-ended or inclusive transitional construct and does not exclude additional, unrecited elements, or method steps. For example, a combination that comprises A and B elements, also reads on a combination of A, B, and C elements.

The meaning of “a,” “an,” and “the” include plural references. The meaning of “in” includes “in” and “on.” Additionally, a reference to the singular includes a reference to the plural unless otherwise stated or is inconsistent with the disclosure herein.

The term “or” is an inclusive “or” operator, and includes the term “and/or,” unless the context clearly dictates otherwise.

The phrase “in one embodiment,” as used herein does not necessarily refer to the same embodiment, although it may.

The term “based on” is not exclusive and provides for being based on additional factors not described, unless the context clearly dictates otherwise.

The term “flow” includes a flow of packets through a network. The term “connection” refers to a flow or flows of messages that typically share a common source and destination.

Briefly stated, the present invention is directed to a method and system for managing multiple management servers by a unified session manager. The unified session manager may authenticate a user requesting access to a network appliance. The unified session manager then establishes a session with a management server associated with a component application, based, in part, on the request for access. The unified session manager translates graphical user interface (GUI) messages, network addresses, and the like, between the user and the management server, while the user is in the session with the network appliance. This provides the user with a uniform interface for the plurality of management servers associated with the network appliance.

Illustrative Operating Environment

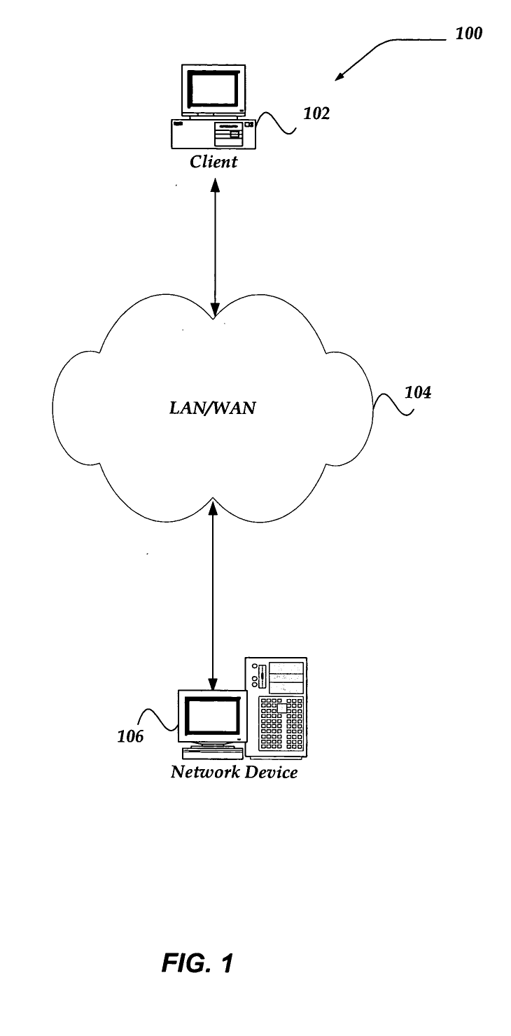

FIG. 1 illustrates one embodiment of an environment in which the invention may operate. Not all the components may be required to practice the invention, and variations in the arrangement and type of the components may be made without departing from the spirit or scope of the invention.

As shown in the figure, system 100 includes Local Area Network/Wide Area Network (LAN/WAN) 104, client 102, and a network device 106. Client 102 and network device 106 are in communication over LAN/WAN 104.

LAN/WAN 104 is enabled to employ any form of computer readable media for communicating information from one electronic device to another. In addition, LAN/WAN 104 may include the Internet in addition to local area networks, wide area networks, direct channels, such as through a universal serial bus (USB) port, other forms of computer-readable media, and any combination thereof. On an interconnected set of LANs, including those based on differing architectures and protocols, a router acts as a link between LAN's, enabling messages to be sent from one to another. Also, communication links within LANs typically include twisted pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices may be remotely connected to either LANs or WANs via a modem and temporary telephone link. In essence LAN/WAN 104 may include any communication mechanism by which information may travel between network devices, such as client 102 and network device 106.

Client 102 may be any network device capable of communicating over a network, such as LAN/WAN 104, to network device 106, and the like. Client 102 may allow one or more users, such as an administrator to access resources over LAN/WAN 104 such as network device 106. The set of such devices may include devices that typically connect using a wired communications medium such as personal computers, multiprocessor systems, microprocessor-based or programmable consumer electronics, network PCs, and the like, that are configured to operate as a client. The set of such devices may also include devices that typically connect using a wireless communications medium such as cell phones, smart phones, pagers, radio frequency (RF) devices, infrared (IR) devices, CBs, integrated devices combining one or more of the preceding devices, and the like, that are configured as a client. Alternatively, client 102 may be any device that is capable of connecting using a wired or wireless communication medium such as a PDA, POCKET PC, wearable computer, and any other device that is equipped to communicate over a wired and/or wireless communication medium, operating as a client.

Network device 106 may include any computing device or devices capable of providing a user access to a resource, such as an application on network device 106, and the like. Devices that may operate as network device 106 include, but are not limited to, personal computers, desktop computers, multiprocessor systems, microprocessor-based or programmable consumer electronics, network PCs, web servers, cache servers, file servers, routers, gateways, switches, bridges, firewalls, proxies, and the like. In one embodiment network device 106 may operate as a network appliance comprising a plurality of applications and their associated management servers.

Although not shown, a plurality of applications and their associated management servers may reside in network device 106 or reside in another network device and be managed by network device 106.

General and Illustrative Operations

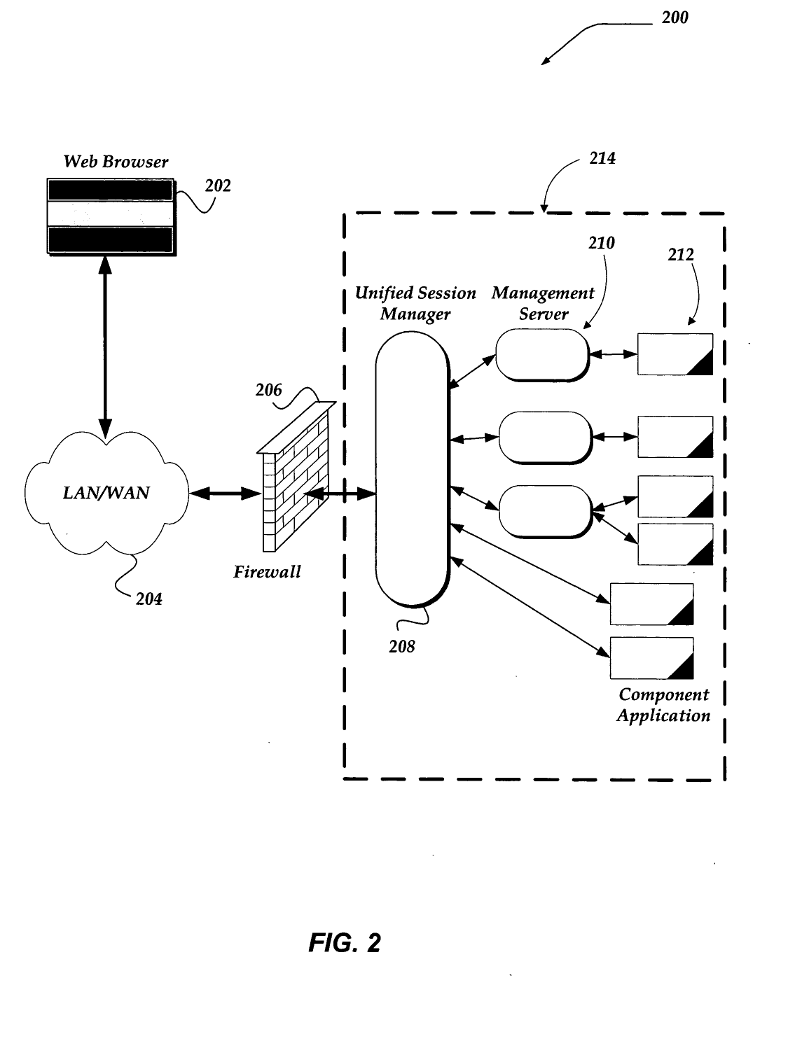

FIG. 2 illustrates a functional block diagram of one embodiment of a network appliance 214 within system 200 in which the present invention may be practiced. Network appliance 214 provides one embodiment for network device 106 of FIG. 1. It will be appreciated that not all components of system 200 and network appliance 214 are illustrated, and that system 200 and network appliance 214 may include more or less components than those shown in the figure.

As illustrated in FIG. 2, system 200 includes web browser 202, LAN/WAN 204, firewall 206, and network appliance 214.

Web browser 202 may be any application capable of communicating over a network, such as LAN/WAN 204, to network appliance 214, and the like. The set of such applications may include applications that typically connect using a network connection. Web browser 202 may include, but not limited to, Internet Explorer™, Netscape Browser™, and the like. Web browser 202 may reside in one embodiment of client 102 of FIG. 1, and may communicate with network appliance 214 via HTML, a proprietary computer language, and the like. In one embodiment, web browser 202 may provide a user with an integrated GUI for any available applications from network appliance 214. Although web browser 202 illustrates a browser application, virtually any windowing application may be employed that enables an interaction with a remote application over the network.

LAN/WAN 204 is substantially the same entity as LAN/WAN 104 as described in FIG. 1 above.

Firewall 206 may be any network device capable of providing specialized network services to network appliance 214, such as protection, translation, routing, and the like. Firewall 206 may include devices such as hubs, network address translators (NATs), routers, gateways, and the like. Firewall 206 may be managed by network appliance 214, by another network device, self-managed, and the like.

Network appliance 214 may be any network device employing a plurality of applications and associated management servers. Network appliance 214 may be constructed in distributed or integrated form, and it may include unified session manager 208, management server 210, and component application 212.

Unified session manager 208 may provide a unified interface to users such as web browser 202. Unified session manager 208 may interact with a plurality of management servers 210 associated with network appliance 214. Unified session manager 208 may further manage independent component application 212.

In one embodiment, unified session manager 208 may authenticate a user seeking access to an application on network appliance 214 from web browser 202. If the sought application is associated with management server 210, unified session manager 208 may authenticate itself to management server 210, establish a session and perform translation between the user and management server 210 to provide a unified interface to the user.

In another embodiment, unified session manager 208 may provide the user direct access to one or more component applications 212, if the application is directly managed by unified session manager 208.

Unified session manager 208, management server 210, and component application 212 may be implemented by computer program instructions, special purpose hardware-based systems, which perform the specified actions or steps, or combinations of special purpose hardware and computer instructions, and the like.

In yet another embodiment, management server 210 may be accessible only by unified session manager 208. Access to management server 210 may be blocked to external hosts, such as client 102 in FIG. 1. Firewall software may be incorporated into network appliance 314 to block requests from external hosts.

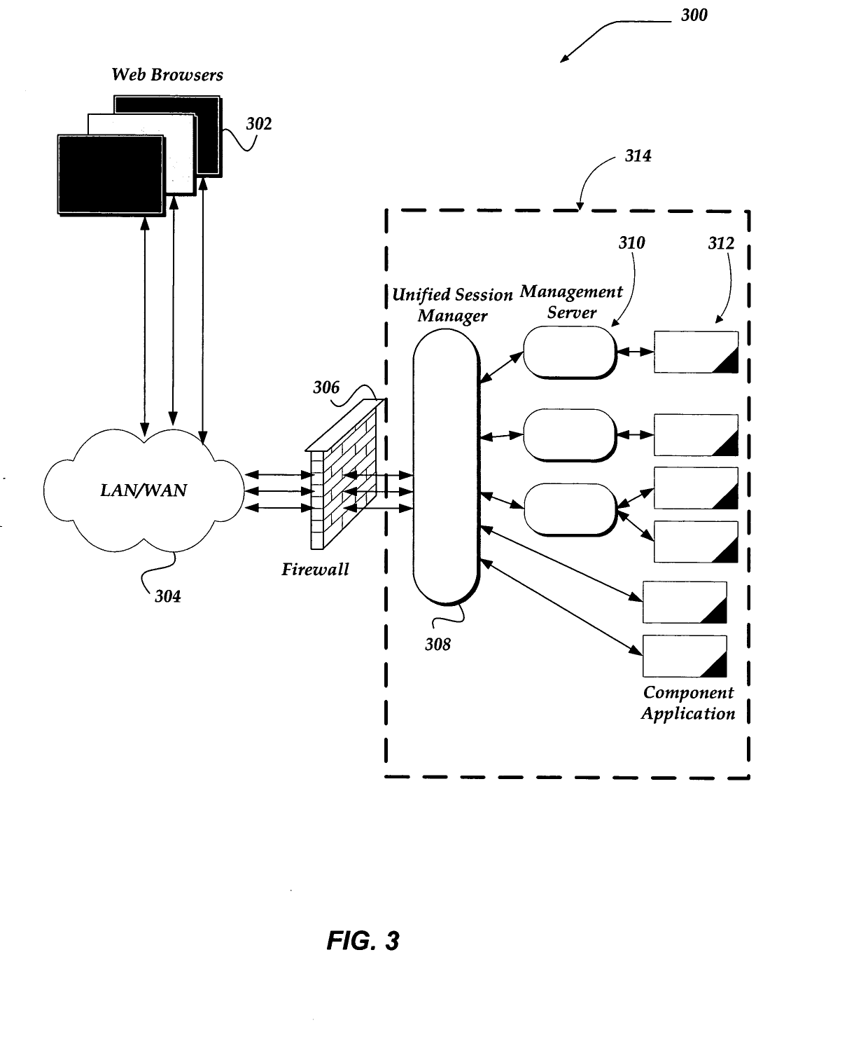

FIG. 3 illustrates a functional block diagram of another embodiment of a network appliance 314 within system 300 in which the present invention may be practiced. As in FIG. 2, network appliance 314 provides one embodiment for network device 106 of FIG. 1. It will be appreciated that not all components of system 300 and network appliance 314 are illustrated, and that system 300 and network appliance 314 may include more or less components than those shown in the figure.

FIG. 3 includes three representative web browsers (302) compared to the single web browser of FIG. 2. Each of the browsers in web browsers 302 may be substantially identical to web browser 202 of FIG. 2. Web browsers 302 may provide a user seeking access to an application on network appliance 314 and individual GUI for each application. Each web server 302, GUI components residing in web browsers 302, and the like, may communicate with network appliance 314 over LAN/WAN 304 using one or more channels.

LAN/WAN 304 is substantially the same as LAN/WAN 204 as described in FIG. 2 above.

Firewall 306 is also substantially the same as firewall 206 of FIG. 2 above. Network appliance 314 is substantially similar to network appliance 214 of FIG. 2. As in FIG. 2, unified session manager 308 may manage a plurality of component applications 312 directly and provide access to users. For other component applications 312 managed by one or more management servers 310, unified session manager 308 may perform actions including authentication to management servers 310, translation between the user and management servers 310. Management servers 310 may manage one or more component applications 312.

Unified session manager 308 may retrieve an authentication token for requests from one of web browsers 302, GUI components of web browsers 302, and the like, and pass the information to another web browser, GUI components of web browsers 302, and the like, via secure communication channel.

Unified session manager 308, management server 310, and component application 312 may be implemented by computer program instructions, special purpose hardware-based systems, which perform the specified actions or steps, or combinations of special purpose hardware and computer instructions, and the like.

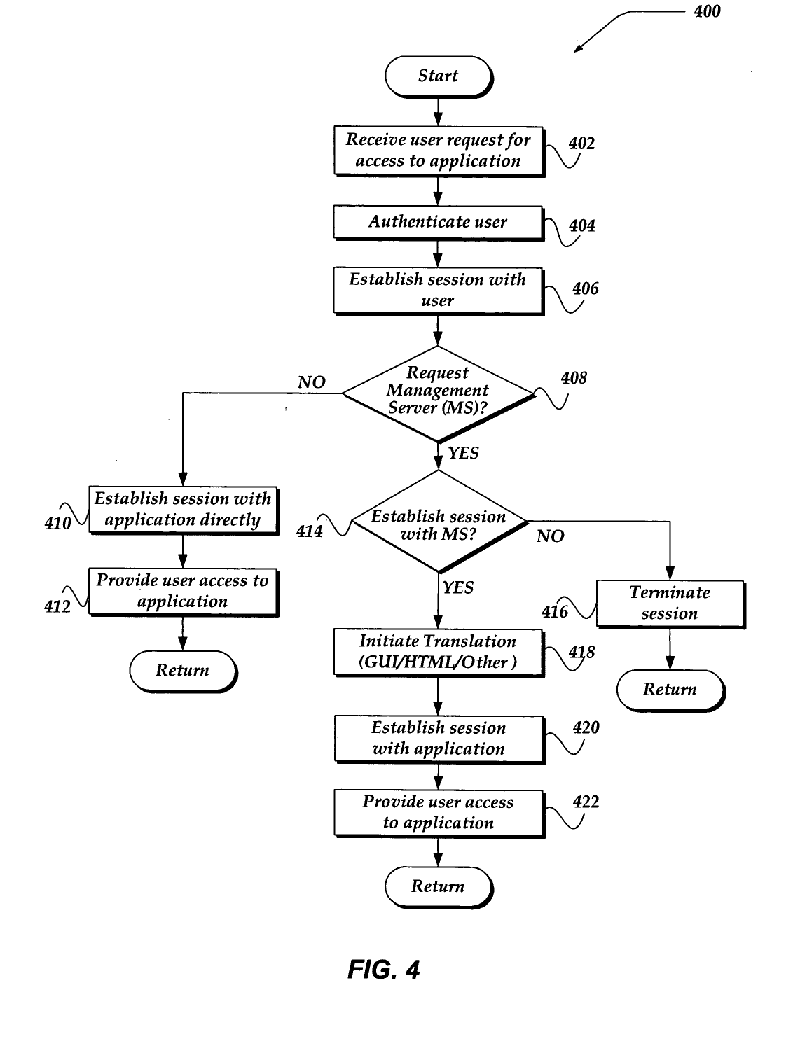

FIG. 4 illustrates a flow diagram generally showing process 400 for managing a network device to provide a unified user interface, according to one embodiment of the invention. Process 400 may, for example, be implemented in network device 106 of FIG. 1.

As shown in FIG. 4, process 400 begins, after a start block, at block 402, where a unified session manager receives a request for access from a user to an application on the network device. The unified session manager may or may not reside on the network device. Processing then proceeds to block 404.

At block 404, the unified session manager authenticates the user. Authentication may include verification of a login password, verification of a digital signature, recognition of the user's MAC address, and the like. Processing then proceeds to block 406.

At block 406, the unified session manager establishes a session with the user and determines which application the user is trying to access. An application on the network device may be directly managed by the unified session manager. Another application on the network device may be managed by a separate management server. Process 400 proceeds to decision block 408.

At block 408 a decision is made whether a separate management server is involved with the remainder of process 400 or not. The decision is based, in part, on the determination of the unified session manager at block 406. If a management server is involved, processing proceeds to block 414. If the requested application is managed directly by the unified session manager, processing proceeds to block 410.

At block 410, the unified session manager establishes a session with the application directly. Processing then proceeds to block 412.

At block 412, the unified session manager provides the user access to the application by modifying requests and responses between the user and the application. Upon completion of block 412, process 400 may return to a calling process to perform other actions.

At decision block 408, if a management server is involved, processing proceeds to block 414. Block 414 is another decision block, where the unified session manager determines if it can establish a session with the management server. Establishing a session with the management server may include providing the management server a login password independent from the login password used to authenticate the user. Establishing a session with the management server may further include providing a digital signature, an authentication certificate, and the like. If the session with the management server is not established at block 414, processing proceeds to block 416, where communication is terminated and process 400 may return to a calling process to perform other actions.

If the session with the management server is established at block 414, processing proceeds to block 418, where the unified session manager initiates a brokering session. Brokering session may be performed to provide the user with a unified interface independent of the management server. Brokering session may include translating GUI messages between the user and the management server to conform the messages to a unified format. Brokering session may further include modifying network addresses such as URLs between the user and the management server, attaching additional information to requests and responses, and the like. Process 400 then proceeds to block 420.

At block 420, the unified session manager establishes a session with the requested application through the management server. Upon verification of the session with the application and completion of block 420, processing proceeds to block 422.

At block 422, the unified session manager provides the user access to the application. The management server's involvement is transparent to the user. Upon completion of block 422, process 400 may return to a calling process to perform other actions.

It will be understood that each block of the flowchart illustrations discussed above, and combinations of blocks in the flowchart illustrations above, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor, provide steps for implementing the actions specified in the flowchart block or blocks.

Although the invention is described in terms of communication between a unified session manager and a user, the invention is not so limited. For example, the communication may be between virtually any resource, including but not limited to multiple users, multiple servers, and any other device, without departing from the scope of the invention.

Accordingly, blocks of the flowchart illustrations support combinations of means for performing the specified actions, combinations of steps for performing the specified actions and program instruction means for performing the specified actions. It will also be understood that each block of the flowchart illustrations, and combinations of blocks in the flowchart illustrations, can be implemented by special purpose hardware-based systems, which perform the specified actions or steps, or combinations of special purpose hardware and computer instructions.

1. A method for managing a network device over a network, comprising:
receiving a request from a client device for access to an application associated with the network device;
establishing a session between a unified session manager and a management server associated with the application;
modifying the request at the unified session manager;
forwarding, by the unified session manager, the modified request to the management server;
receiving a response at the unified session manager from the management server;
modifying the response at the unified session manager; and
forwarding, by the unified session manager, the modified response to the client device.

2. The method of claim 1, wherein the request is authenticated by the unified session manager.

3. The method of claim 1, wherein establishing the session with the management server further comprises authenticating the unified session manager to the management server, wherein the authentication is virtually transparent to the client device.

4. The method of claim 1, wherein modifying the request further comprises translating a graphical user interface (GUI) message and, wherein modifying the response further comprises translating another graphical user interface (GUI) message.

5. The method of claim 4, wherein at least one of the GUI message and the other GUI message is translated into a unified format.

6. The method of claim 1, wherein modifying the request further comprises modifying a network address before forwarding the modified request, and wherein modifying the response further comprises modifying another network address before forwarding the modified response.

7. The method of claim 1, wherein modifying the response further comprises enabling a download of a file from the unified session manager.

8. A unified session manager for managing a network device, comprising:
a transceiver configured to receive a request from a client for access to an application on the network device and to forward a response to the request;
a processor, coupled to the transceiver, that is configured to perform actions including:
establishing a session on behalf of the client between the unified session manager and a management server associated with the application;
modifying the request;
forwarding the modified request to the management server;
receiving the response on behalf of the client from the management server associated with the application;
modifying the response; and
forwarding the modified response from the management server to the transceiver.

9. The unified session manager of claim 8, wherein the processor is further configured to authenticate the request.

10. The unified session manager of claim 8, wherein the processor is further configured to authenticate to the management server, and wherein the authentication is virtually transparent to the client.

11. The unified session manager of claim 10, wherein the authentication to the management server further comprises sending at least one of a password, a certificate, and an encryption key.

12. The unified session manager of claim 8, wherein the processor is further configured to modify at least one of the request and the response by translating at least one GUI message.

13. The unified session manager of claim 8, wherein the unified session manager is configured to perform further actions, comprising:
establishing another session on behalf of the client with another application;
modifying another request;
forwarding the other modified request to the application;
receiving another response on behalf of the client from the application;
modifying the other response; and
forwarding the other modified response to the transceiver.

14. The unified session manager of claim 8, wherein the processor is further configured to enable a plurality of clients to access virtually simultaneously a plurality of applications on the network device.

15. A method for managing a plurality of management servers, comprising:
establishing a session between a unified session manager and at least one of the plurality of the management servers, wherein the unified session manager is enabled to operate on behalf of at least one of a plurality of clients; and
modifying each message from the at least one of the plurality of clients destined for an application associated with the at least one of the plurality of the management servers, wherein the modification is virtually transparent to the client and to the management server.

16. The method of claim 15, wherein the unified session manager is enabled to operate on behalf of each of the plurality of clients seeking access to the at least one of the plurality of management servers.

17. The method of claim 15, wherein establishing the session between the unified session manager and the at least one of the plurality of the management servers further comprises performing an authentication to the at least one of the plurality of the management servers, and wherein the authentication is virtually transparent to the at least one of the plurality of the clients.

18. The method of claim 15, wherein modifying each message between the at least one of the plurality of the clients and the at least one of the plurality of the management servers further comprises at least one of wrapping a Java applet, and translating a URL.

19. In a computer system having a graphical user interface including a display and a user interface selection device, a method for providing a selection menu on the display to manage a remote application over a network, comprising:
retrieving a set of menu entries including at least one menu entry that is associated with the remote application;
displaying the selection menu on the display comprising the set of menu entries;
retrieving a menu entry selection signal, wherein the menu entry selection signal is modified by a unified session manager;
forwarding the modified menu entry selection signal to a management server associated with the remote application;
receiving another signal indicative of a response from the management server, wherein the other signal is modified by the unified session manager; and
displaying the other modified signal at the display.

20. The method of claim 19, wherein the menu entry selection signal comprises, a request for authentication, and a request for a program download.

21. The method of claim 19, wherein modifying the menu entry selection signal further comprises translating a GUI message, altering a network address, and attaching additional information to the signal.

22. The method of claim 19, wherein modifying the other signal, indicative of a response from the management server, further comprises translating a GUI message, altering a network address, and attaching additional information to the signal.

23. A device manager for managing a network device, comprising:
a means for establishing a session with a management server associated with an application on behalf of a remote client;
a means for modifying the request;
a first forwarding component configured to forward the modified request to the management server;
a means for receiving a response from the management server;
a means for modifying the response; and
a second forwarding component configured to forward the modified response to the remote client.
